(19) United States
(12) Patent Application Publication
(10) Pub. No.: US 2024/0122372 A1
(43) Pub. Date: Apr. 18, 2024

(54) SYSTEM AND METHOD FOR ENHANCING SAFETY OF A BABY WALKER

(71) Applicant: Michael Gronwald, South Ogden, UT (US)

(72) Inventor: Michael Gronwald, South Ogden, UT (US)

(21) Appl. No.: 17/965,709

(22) Filed: Oct. 13, 2022

Related U.S. Application Data
(60) Provisional application No. 63/255,011, filed on Oct. 13, 2021.

(51) Int. Cl. A47D 13/04; A47D 15/00

(52) U.S. Cl. CPC A47D 13/043; A47D 15/00

(57) ABSTRACT

A system and method for enhancing the safety of a baby walker is provided. The system includes a computing system connected to one or more electronic devices via a network. Mounted on the baby walker is a monitoring system and a response system. The computing system detects one or more fatal conditions based on one or more safety inputs from a user and one or more safety parameters detected by the monitoring system and determines one or more safety actions to be performed by the response system.

### COPYRIGHT AND TRADE DRESS NOTICE

A portion of the disclosure of this patent document contains material that is subject to copyright or trade dress protection. This patent document may show and/or describe matter that is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### BACKGROUND

### 1. Field of the Invention

The present invention relates generally to baby safety management systems, and more specifically, to a system and method for enhancing the safety of a baby walker.

### 2. Description of Related Art

This background information is intended to further educate the reader as to additional aspects of the prior art and may present examples of specific aspects of the prior art that is not to be construed as limiting the disclosure of the present application.

A baby walker is a device that helps an infant learn to walk from one place to another in an upright position by using their legs. The baby walker includes a frame to hold an infant, such that the legs of the infant extend downward and contact a walking surface such as a floor. Further, the frame is mounted on wheels to facilitate movement of the baby walker. When the infant pushes the baby walker using his/her legs, the baby walker moves in a direction of force applied by the infant via the wheels. However, the use of baby walkers may lead to serious injuries to the infants by tripping, falling over, rolling down stairs, skidding on wet floors, hitting an obstacle and the like. According to the official journal of the American Academy of Pediatrics, nearly 230,676 children less than 15 months were treated for baby walker-related injuries in the U.S. from 1990 to 2014. Furthermore, a baby walker may allow infants to reach potentially dangerous areas, such as bathtubs, kitchens, swimming pools and the like.

Accordingly, although great advances have been made in the area of baby safety management systems, some deficiencies remain.

### SUMMARY

The disclosure of the present application addresses the above stated deficiencies with baby safety management systems. The system and method of the present application is unique when compared with other known baby safety management systems because it provides a means for limiting the movement of a baby walker to particular safe areas.

In accordance with an embodiment of the present disclosure, a computing system for enhancing safety of a baby walker is disclosed. The computing system includes one or more hardware processors and a memory coupled to the one or more hardware processors. The memory includes a plurality of modules in the form of programmable instructions executable by the one or more hardware processors. The plurality of modules includes a data receiver module configured to receive one or more safety inputs corresponding to a baby walker from a guardian of an infant using the baby walker. The one or more safety inputs may include: a desired speed, a desired acceleration, a desired virtual perimeter and a desired position of the baby walker and the like. The data receiver module is also configured to receive one or more safety parameters corresponding to the baby walker detected by using a monitoring device mounted on the baby walker. The monitoring device may include a Global Positioning System (GPS) device and one or more sensors. The one or more safety parameters may include: speed, acceleration, position of the baby walker, drop-off in proximity of the baby walker and obstacles in a movement path of the baby walker. Further, the plurality of modules include a condition detection module configured to detect one or more fatal conditions associated with the baby walker based on the received one or more safety inputs and the received one or more safety parameters. The one or more fatal conditions may include: speed, acceleration and position of the baby walker exceeding the desired speed, the desired acceleration and the desired position respectively, drop-off in proximity of the baby walker, baby walker about to leave the desired virtual perimeter and obstacle in a movement path of the baby walker. The plurality of modules further include an action determination module configured to determine one or more safety actions to be performed by a response device mounted on the baby walker based on the detected one or more fatal conditions and a predefined information. The response device may include: a breaking device and a walker handling device. The one or more safety actions may include: stopping the baby walker, changing direction, speed, acceleration and position of the baby walker. The plurality of modules further include a data output module configured to output the detected one or more fatal conditions on a graphical user interface of one or more electronic devices associated with the guardian.

In accordance with another embodiment of the present disclosure, a method for enhancing safety of a baby walker is disclosed. The method includes receiving one or more safety inputs corresponding to a baby walker from a guardian of an infant using the baby walker. The one or more safety inputs may include: a desired speed, a desired acceleration, a desired virtual perimeter and a desired position of the baby walker. The method also includes receiving one or more safety parameters corresponding to the baby walker detected by using a monitoring device mounted on the baby walker. The monitoring device may include a Global Positioning System (GPS) device and one or more sensors. The one or more safety parameters may include: speed, acceleration, position of the baby walker, drop-off in proximity of the baby walker and obstacles in a movement path of the baby walker. Furthermore, the method includes detecting one or more fatal conditions associated with the baby walker based on the received one or more safety inputs and the received one or more safety parameters. The one or more fatal conditions may include: speed, acceleration and position of the baby walker exceeding the desired speed, the desired acceleration and the desired position respectively, drop-off in proximity of the baby walker, baby walker about to leave the desired virtual perimeter and obstacle in a movement path of the baby walker. The method further includes determining one or more safety actions to be performed by a response device mounted on the baby walker based on the detected one or more fatal conditions and a predefined information. The response device may include: a breaking device and a walker handling device. The one or more safety actions may include: stopping the baby walker, changing direction, speed, acceleration and position of the baby walker. Further, the method includes outputting the detected one or more fatal conditions on a graphical user interface of one or more electronic devices associated with the guardian.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a block diagram illustrating a system for enhancing the safety of a baby walker in accordance with a preferred embodiment of the present application;

FIG. 2 is a simplified schematic illustrating a computing system as implemented in the system of FIG. 1; and

FIG. 3 is a flowchart illustrating a method for enhancing the safety of a baby walker in accordance with a preferred embodiment of the present application.

While the system of the present application is subject to various modifications and alternative forms, specific embodiments have been shown by way of example in the drawings and are described in detail. It should be understood that the description of specific embodiments is not intended to limit the invention to the particular embodiment disclosed, but rather to cover all modifications, equivalents, and alternatives falling within the scope of the present application as defined by the appended claims.

### DETAILED DESCRIPTION

Illustrative embodiments of the system of the present application are provided herein. It should be appreciated that in the development of any actual embodiment, various implementation-specific decisions are required to achieve the developer's specific goals, such as compliance with system-related and business-related constraints, which vary from one implementation to another. Moreover, it should be appreciated that such a development effort might be complex and time-consuming but would nevertheless be a routine undertaking for those of ordinary skill in the art having the benefit of this disclosure.

The system in accordance with the present application overcomes one or more of the above-discussed shortcomings commonly associated with baby safety management systems. Specifically, the system and method incorporate a means for guiding a baby walker in a safe direction and avoiding dangerous areas. These and other unique features of the system are discussed below and illustrated in the accompanying drawings.

The system should be understood, both as to its structure and operation, from the accompanying drawings, taken in conjunction with the accompanying description. Various embodiments of the system may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or subsystems or elements or structures or components preceded by “comprises” does not, without more constraints, preclude the existence of other devices, sub-systems, additional sub-modules. Appearances of the phrase “in an embodiment”, “in another embodiment” and similar language throughout this specification may, but not necessarily, refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting. A computer system (standalone, client or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed, permanently configured (hardwired) or temporarily configured (programmed) to operate in a certain manner and/or to perform certain operations described herein.

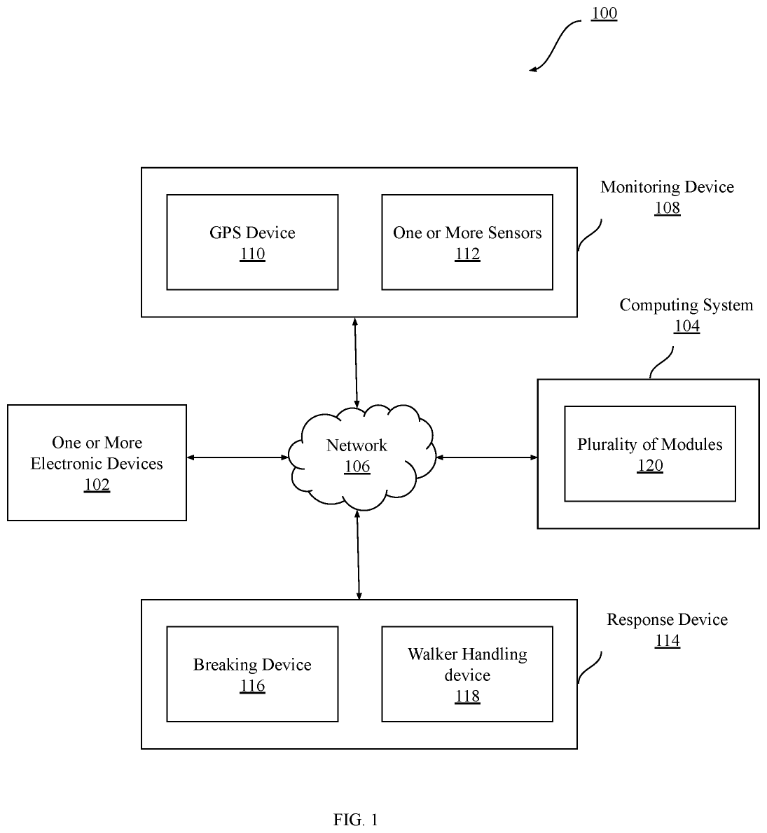

Referring now to the drawings, and more particularly to FIGS. 1-3, where similar reference characters denote corresponding features consistently throughout the figures, there are shown preferred embodiments and these embodiments are described in the context of the following exemplary system and/or method.

FIG. 1 is a block diagram illustrating an exemplary computing environment 100 capable of enhancing safety of a baby walker, in accordance with an embodiment of the present disclosure. In an embodiment of the present disclosure, the baby walker is a device that helps infants to walk from one place to another in an upright position by using their legs. According to FIG. 1, the computing environment 100 includes one or more electronic devices 102 communicatively coupled to a computing system 104 via a network 106. In an exemplary embodiment of the present disclosure, the one or more electronic devices 102 may be a tablet computer, smartphone and the like. The one or more electronic devices 102 may be associated with a guardian of the infant using the baby walker. In an exemplary embodiment of the present disclosure, the network 106 may be the Internet or the like. In an alternative embodiment of the present disclosure, the network 106 may also be a hardware device, such as a Bluetooth device or the like. The computing system 104 may be a central server, such as a cloud server or a remote server or the like. Further, the one or more electronic devices 102 may include a mobile application to access the computing system 104 via the network 106. The mobile application may support Android platforms, iOS platforms and the like. The guardian may use the computing system 104 to provide one or more safety inputs corresponding to the baby walker via the mobile application. Further, the guardian may also use the computing system 104 to perform one or more safety actions and receive one or more fatal conditions associated with the baby walker via the mobile application.

Further, the computing environment 100 also includes a monitoring device 108 communicatively coupled to the computing system 104 via the network 106. The monitoring device 108 is mounted on the baby walker and configured to detect one or more safety parameters corresponding to the baby walker. In an exemplary embodiment of the present disclosure, the one or more safety parameters may include speed, acceleration, position of the baby walker, drop-off in proximity of the baby walker, obstacles in path of the baby walker and the like. The monitoring device 108 may include a Global Positioning System (GPS) device 110 to detect position of the baby walker. Furthermore, the monitoring device 108 also includes one or more sensors 112 to detect speed, acceleration, drop-off in proximity of the baby walker, obstacles in a path of the baby walker and the like.

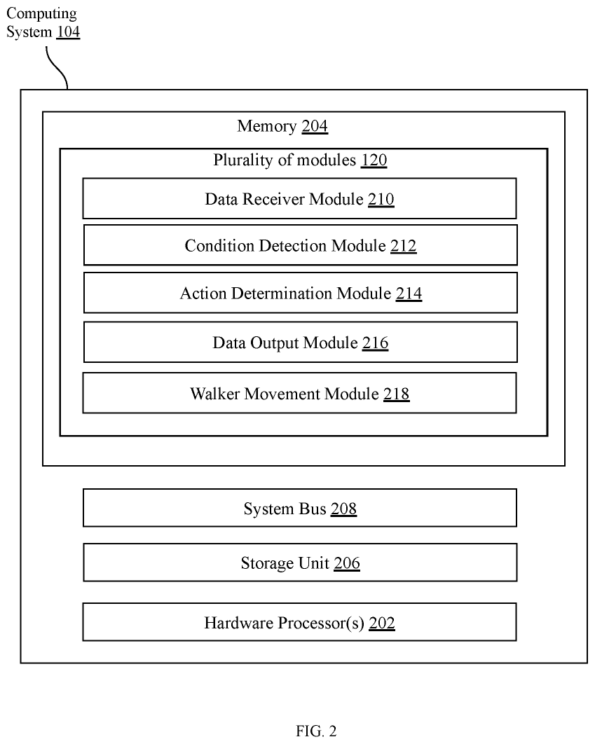

Furthermore, the computing environment 100 also includes a response device 114 communicatively coupled to the computing system 104 via the network 106. The response device 114 is mounted on the baby walker and configured to perform one or more safety actions in order to enhance safety of the baby walker. In an exemplary embodiment of the present disclosure, the one or more actions may include stopping the baby walker, changing direction, speed, acceleration, position of the baby walker and the like. The response device 114 includes a braking device 116 configured to stop the baby walker by applying brakes on wheels of the baby walker. Further, the response device 114 also includes a walker handling device 118 configured to change direction, speed, acceleration and position of the baby walker. The computing system 104 includes a plurality of modules 120. Details on the plurality of modules 120 have been elaborated in subsequent paragraphs of the present description with reference to FIG. 2.

In an embodiment of the present disclosure, the computing system 104 receives the one or more safety inputs corresponding to the baby walker from the guardian. Further, the computing system 104 receives the one or more safety parameters corresponding to the baby walker detected by using the monitoring device 108 mounted on the baby walker. The computing system 104 also detects the one or more fatal conditions associated with the baby walker based on the received one or more safety inputs and the received one or more safety parameters. Furthermore, the computing system 104 determines the one or more safety actions to be performed by a response device 114 mounted on the baby walker based on the detected one or more fatal conditions and a predefined information. The computing system 104 also outputs the detected one or more fatal conditions on a graphical user interface of the one or more electronic devices 102 associated with the guardian

FIG. 2 is a block diagram illustrating an exemplary computing system 104, such as those shown in FIG. 1, capable of enhancing safety of the baby walker. The computing system 104 comprises one or more hardware processors 202, a memory 204 and a storage unit 206. The one or more hardware processors 202, the memory 204 and the storage unit 206 are communicatively coupled through a system bus 208 or any similar mechanism. The memory 204 comprises the plurality of modules 120 in the form of programmable instructions executable by the one or more hardware processors 202. Further, the plurality of modules 120 includes a data receiver module 210, a condition detection module 212, an action determination module 214, a data output module 216 and a walker movement module 218.

The one or more hardware processors 202, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 202 may also include embedded controllers, such as generic or programmable logic devices or arrays, application specific integrated circuits, single-chip computers, and the like.

The memory 204 may be non-transitory volatile memory and non-volatile memory. The memory 204 may be coupled for communication with the one or more hardware processors 202, such as being a computer-readable storage medium. The one or more hardware processors 202 may execute machine-readable instructions and/or source code stored in the memory 204. A variety of machine-readable instructions may be stored in and accessed from the memory 204. The memory 204 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 204 includes the plurality of modules 120 stored in the form of machine-readable instructions on any of the above-mentioned storage media and may be in communication with and executed by the one or more hardware processors 202.

The storage unit 206 may be a cloud storage or a local file directory within a remote server. The storage unit 206 may store one or more inputs and one or more safety parameters. Further, the storage unit 206 also stores predefined information.

The data receiver module 210 is configured to receive one or more safety inputs corresponding to the baby walker from a guardian of an infant using the baby walker. The data receiver module 210 may receive the one or more safety inputs from one or more electronic devices 102 associated with the guardian. In an exemplary embodiment of the present disclosure, the one or more safety inputs may include a desired speed, a desired acceleration, a desired virtual perimeter, a desired position of the baby walker and the like. The desired virtual perimeter is an area set by the guardian in which the baby walker is allowed to move. The baby walker may not leave the desired virtual perimeter. In an embodiment of the present disclosure, the guardian may provide the one or more safety inputs for controlling the baby walker in accordance with the one or more safety inputs. Further, the data receiver module 210 receives one or more safety parameters corresponding to the baby walker detected by using a monitoring device 108 mounted on the baby walker. The monitoring device 108 includes a Global Positioning System (GPS) device 110 and one or more sensors 112. In an exemplary embodiment of the present disclosure, the one or more safety parameters may include speed, acceleration, position of the baby walker, drop-off in proximity of the baby walker, obstacles in path of the baby walker and the like. For example, the drop-off in proximity of the baby walker may be a staircase. In an embodiment of the present disclosure, the GPS device 110 is configured to detect a position of the baby walker. Furthermore, the one or more sensors 112 are configured to detect speed, acceleration, drop-off in proximity of the baby walker, obstacles in a path of the baby walker and the like. The guardian may access the one or safety parameters corresponding to the baby walker to be aware of current speed, acceleration and position of the baby walker.

The condition detection module 212 is configured to detect one or more fatal conditions associated with the baby walker based on the received one or more safety inputs and the received one or more safety parameters. In an exemplary embodiment of the present disclosure, the one or more fatal conditions may include speed, acceleration and position of the baby walker exceeding the desired speed, the desired acceleration and the desired position respectively, drop-off in proximity of the baby walker, baby walker about to leave the desired virtual perimeter and obstacle in path of the baby walker.

The action determination module 214 is configured to determine one or more safety actions to be performed by a response device 114 mounted on the baby walker based on the detected one or more fatal conditions and a predefined information. The response device 114 includes a breaking device 116 and a walker handling device 118. In an exemplary embodiment of the present disclosure, the one or more safety actions may include stopping the baby walker, changing direction, speed, acceleration, position of the baby walker and the like. In an embodiment of the present disclosure, the braking device 116 is configured to stop the baby walker by applying brakes on wheels of the baby walker. Further, the walker handling device 118 is configured to change direction, speed, acceleration and position of the baby walker. The one or more safety actions may be performed to keep the baby walker in the desired virtual perimeter, prevent the baby walker to collide with the obstacles in the desired virtual perimeter, prevent the baby walker from dropping off and maintaining speed, acceleration and position of the baby walker as per the one or more safety inputs. In an embodiment of the present disclosure, the predefined information is in the form of a look-up table which facilitates in determining one or more safety actions corresponding to the detected fatal condition. For example, when the condition detection module 212 detects a staircase in proximity of the baby walker, the action determination module 214 may use the predefined information to determine one or more safety actions corresponding to the detected staircase, such as stopping the baby walker and move the baby walker in a direction opposite to the staircase for preventing the infant from falling down the stairs.

The data output module 216 is configured to output the detected one or more fatal conditions on a graphical user interface of one or more electronic devices 102 associated with the guardian. In an embodiment of the present disclosure, the data output module 216 may output the detected one or more fatal conditions in the form of an alarm to alert the guardian about the detected one or more fatal conditions.

In an embodiment of the present disclosure, the walker movement module 218 is configured to receive one or more movement inputs from the guardian in order to control the baby walker. The guardian may provide the one or more movement inputs via the one or more electronic devices 102. In an embodiment of the present disclosure, the one or more movement inputs are inputs to move the baby walker in forward, backward, leftward and rightward direction. Further, the walker movement module 218 directs the walker handling device 118 to move the baby walker in a desired direction based on the received one or more movement inputs. In an embodiment of the present disclosure, the baby walker may also be controlled manually.

In operation, the computing system 104 receives the one or more safety inputs corresponding to the baby walker from the guardian. Further, the computing system 104 receives the one or more safety parameters corresponding to the baby walker detected by using the monitoring device 108. In an embodiment of the present disclosure, the monitoring device 108 is mounted on the baby walker. The computing system 104 also detects the one or more fatal conditions associated with the baby walker based on the received one or more safety inputs and the received one or more safety parameters. Furthermore, the computing system 104 determines the one or more safety actions to be performed by the response device 114 mounted on the baby walker based on the detected one or more fatal conditions and the predefined information. The computing system 104 further outputs the detected one or more fatal conditions on the graphical user interface of the one or more electronic devices 102 associated with the guardian.

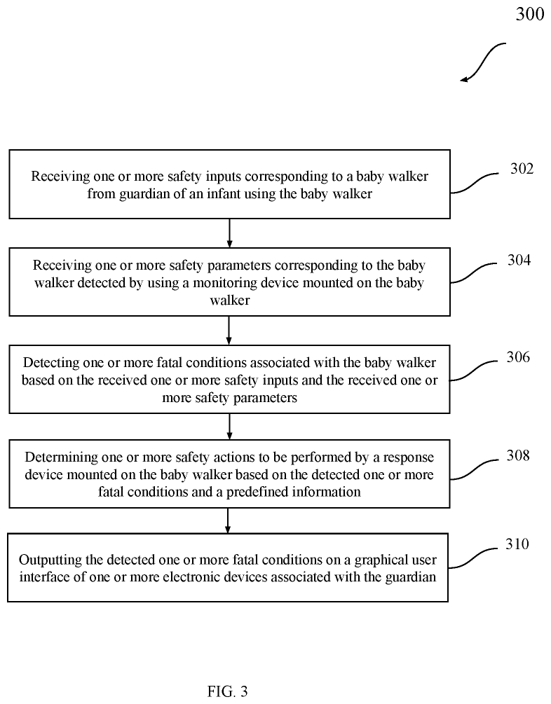

FIG. 3 is a process flow diagram illustrating an exemplary method 300 for enhancing safety of the baby walker in accordance with an embodiment of the present disclosure. At step 302, one or more safety inputs corresponding to a baby walker is received from a guardian of an infant using the baby walker. The one or more safety inputs may be received from one or more electronic devices 102 associated with the guardian. In an exemplary embodiment of the present disclosure, the one or more electronic devices 102 may be a tablet computer, smartphone and the like. In an exemplary embodiment of the present disclosure, the one or more safety inputs may include a desired speed, a desired acceleration, a desired virtual perimeter, a desired position of the baby walker and the like. The desired virtual perimeter is an area set by the guardian in which the baby walker is allowed to move. The baby walker may not leave the desired virtual perimeter. In an embodiment of the present disclosure, the guardian may provide the one or more safety inputs for controlling the baby walker in accordance with the one or more safety inputs.

At step 304, one or more safety parameters corresponding to the baby walker detected by using a monitoring device 108 mounted on the baby walker is received. The monitoring device 108 includes a Global Positioning System (GPS) device 110 and one or more sensors 112. In an exemplary embodiment of the present disclosure, the one or more safety parameters include speed, acceleration, position of the baby walker, drop-off in proximity of the baby walker, obstacles in path of the baby walker and the like. For example, the drop-off in proximity of the baby walker may be a staircase. In an embodiment of the present disclosure, the GPS device 110 is configured to detect a position of the baby walker. Furthermore, the one or more sensors 112 are configured to detect speed, acceleration, drop-off in proximity of the baby walker, obstacles in a path of the baby walker and the like. The guardian may access the one or safety parameters corresponding to the baby walker to be aware of current speed, acceleration and position of the baby walker.

At step 306, one or more fatal conditions associated with the baby walker are detected based on the received one or more safety inputs and the received one or more safety parameters. In an exemplary embodiment of the present disclosure, the one or more fatal conditions include speed, acceleration and position of the baby walker exceeding the desired speed, the desired acceleration and the desired position respectively, drop-off in proximity of the baby walker, baby walker about to leave the desired virtual perimeter and obstacle in path of the baby walker.

At step 308, one or more safety actions to be performed by a response device 114 mounted on the baby walker are determined based on the detected one or more fatal conditions and a predefined information. The response device 114 includes a braking device 116 and a walker handling device 118. In an exemplary embodiment of the present disclosure, the one or more safety actions include stopping the baby walker, changing direction, speed, acceleration, position of the baby walker and the like. In an embodiment of the present disclosure, the braking device 116 is configured to stop the baby walker by applying brakes on wheels of the baby walker. Further, the walker handling device 118 is configured to change direction, speed, acceleration and position of the baby walker. The one or more safety actions may be performed to keep the baby walker in the desired virtual perimeter, prevent the baby walker to collide with the obstacles in the desired virtual perimeter, prevent the baby walker from dropping off and maintaining speed, acceleration and position of the baby walker as per the one or more safety inputs. In an embodiment of the present disclosure, the predefined information is in the form of a look-up table which facilitates in determining one or more safety actions corresponding to the detected fatal condition.

At step 310, the detected one or more fatal conditions are outputted on a graphical user interface of one or more electronic devices 102 associated with the guardian. In an embodiment of the present disclosure, the detected one or more fatal conditions are outputted in the form of an alarm to alert the guardian about the detected one or more fatal conditions.

In an embodiment of the present disclosure, the method 300 includes receiving one or more movement inputs from the guardian in order to control the baby walker. The guardian may provide the one or more movement inputs via the one or more electronic devices 102. In an embodiment of the present disclosure, the one or more movement inputs are inputs to move the baby walker in forward, backward, leftward and rightward direction. Further, the method 300 includes directing the walker handling device 118 to move the baby walker in a desired direction based on the received one or more movement inputs. In an embodiment of the present disclosure, the baby walker may also be controlled manually.

The method 300 may be implemented in any suitable hardware, software, firmware, or combination thereof.

Thus, various embodiments of the present computing system 104 provide a solution to enhance safety of the baby walker. Since, the computing system 104 automatically determines the one or more safety actions to be performed by the response device 114 mounted on the baby walker, the infant may be protected from the injuries by tripping, falling over, rolling down stairs, skidding on wet floors, hitting an obstacle and the like. Further, the guardian may provide the one or more safety inputs for controlling the baby walker in accordance with the one or more safety inputs. The computing system 104 may also output the one or more fatal conditions on the graphical user interface of one or more electronic devices 102 to alert the guardian about the one or more fatal conditions. Thus, the guardian may take immediate actions corresponding to the one or more fatal conditions to ensure safety of the infant.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The system herein comprises at least one processor or central processing unit (CPU). The CPUs are interconnected via system bus 208 to various devices such as a random-access memory (RAM), read-only memory (ROM), and an input/output (I/O) adapter. The I/O adapter can connect to peripheral devices, such as disk units and tape drives, or other program storage devices that are readable by the system. The system can read the inventive instructions on the program storage devices and follow these instructions to execute the methodology of the embodiments herein.

The system further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items.

The particular embodiments disclosed herein are illustrative only, as the embodiments may be modified and practiced in different but equivalent manners apparent to those skilled in the art having the benefit of the present disclosure. It is therefore evident that the particular embodiments disclosed herein may be altered or modified, and any such variations are considered to fall within the scope of the present application. Accordingly, the protection sought herein is as set forth in the description and the appended claims as well as any other variations and modifications falling within the scope thereof.

What is claimed is:

1. A system for enhancing the safety of a baby walker, comprising:
a computing system;
one or more electronic devices communicatively coupled to the computing system via a network;
a monitoring system including a plurality of sensors mounted on the baby walker and communicatively coupled to the computing system via the network and configured to detect one or more safety parameters corresponding to the baby walker;
a response system mounted on the baby walker and communicatively coupled to the computing system via the network and configured to perform one or more safety actions;
wherein a user inputs one or more safety inputs into the computing system via the one or more electronic devices;
wherein the computing system detects one or more fatal conditions associated with the baby walker based on the one or more safety inputs and the one or more safety parameters and determines the one or more safety actions to be performed by the response system.

2. The system for enhancing the safety of a baby walker of claim 1, wherein the user receives a notification of the one or more fatal conditions associated with the baby walker via the one or more electronic devices.

3. The system for enhancing the safety of a baby walker of claim 1, wherein the one or more safety parameters include speed of the baby walker, acceleration of the baby walker, position of the baby walker, drop-off in proximity to the baby walker, obstacles in a path of the baby walker, or any combination thereof.

4. The system for enhancing the safety of a baby walker of claim 1, wherein the monitoring system further includes a Global Positioning System (GPS) device to detect a position of the baby walker.

5. The system for enhancing the safety of a baby walker of claim 1, wherein the response system further includes a braking device configured to stop the baby walker.

6. The system for enhancing the safety of a baby walker of claim 1, wherein the response system further includes a baby walker handling device configured to change direction, speed, acceleration and position of the baby walker.

7. The system for enhancing the safety of a baby walker of claim 1, wherein the one or more safety actions include stopping the baby walker, changing direction of the baby walker, changing speed of the baby walker, changing acceleration of the baby walker, changing position of the baby walker, or any combination thereof.

8. The system for enhancing the safety of a baby walker of claim 1, wherein the one or more safety inputs includes a virtual perimeter configured to restrict the movement of the baby walker.

9. A method for enhancing the safety of a baby walker, the method comprising:
receiving one or more safety inputs corresponding to a baby walker from a guardian of an infant using the baby walker;
receiving one or more safety parameters corresponding to the baby walker detected by using a monitoring device mounted on the baby walker;
detecting one or more fatal conditions associated with the baby walker based on the received one or more safety inputs and the received one or more safety parameters;
determining one or more safety actions to be performed by a response device mounted on the baby walker based on the detected one or more fatal conditions and a predefined information; and
outputting the detected one or more fatal conditions on a graphical user interface of one or more electronic devices associated with the guardian.
